(19) United States
(12) Patent Application Publication
(10) Pub. No.: US 2010/0167077 A1
(43) Pub. Date: Jul. 1, 2010

(54) PROCESS FOR PRODUCING PURE METALLIC INDIUM FROM ZINC OXIDE AND/OR SOLUTION CONTAINING THE METAL

(75) Inventor: Adelson Dias de Souza, Tres Marias-MG (BR)

Correspondence Address: CANTOR COLBURN, LLP, 20 Church Street, 22nd Floor, Hartford, CT, 06103, US

(73) Assignee: VOTORANTIM METAIS ZINCO S.A., Tres Marias-MG (BR)

(21) Appl. No.: 12/601,398

(22) PCT Filed: May 21, 2008
(86) PCT No.: PCT/BR08/00150

§ 371 Date: Dec. 17, 2009

(30) Foreign Application Priority Data
May 23, 2007 (BR) PI0701919-0

(51) Int. Cl. B32B 15/00; C25C 1/22; C22C 28/00

(52) U.S. Cl. 428/544; 205/564; 420/555

(57) ABSTRACT

This invention is intended to provide an innovative process to produce pure metallic indium with the use of sulphured concentrates of zinc and lead as sources of the metal. The process begins with the zinc oxide produced by Waelz process from the neutral leaching residues of the zinc oxide calcinate. But the overflow (or supernatant) of the mild leaching of neutral underflow (or residue) of neutral leaching of zinc calcinate also contains indium in lower proportion and may or may not be part of the global process of indium recovery. The new technology is characterized by comprising the following stages: a) Production of indium pre-concentrate; b) Production of indium cement: comprised, in turn, of at least a mild leaching and at least one strong leaching of the indium cement product obtained in the reducing leaching; c) Production of indium solution; d) Extraction of indium by organic solvent; e) Cementation of indium; f) Fusion, purification, and ingoting of the metal; g) Electrolysis of indium to obtain a product with high purity more than 99.995%.

This invention is intended to provide an innovative process to produce pure metallic indium using sulphured concentrates of zinc and lead as sources of the metal. Some patents have already been developed to recover indium from zinc sources, but usually at high costs and very complex processes. Patent CN1664131 refers to a process to remove indium from sulphured zinc minerals using leaching under high pressures. Patent RU2238994 relates to the extraction of indium in a zinc solution, but it does not inform how to obtain this solution and uses organophosphorous reagent to do so. Patent JP3075223 indicates oxalic acid and/or oxalate to extract indium from water solution by adjusting the pH. U.S. Pat. No. 4,292,284 refers only to the extraction with a solvent of indium in water solution using an organic solvent containing monoalkylphosphoric, dialkylphosphoric, and trialkylphosphoric acids. Patent RU2275438 describes only the extraction through solvent of indium from residual solutions using an organic solvent that contains a mixture of tert-butylphenol in octanoic acid.

The Applicant developed a pioneer and complete process to recover indium from sulphured zinc concentrates usually consumed in zinc plants around the world. In general, sulphured concentrates are ustulated to produce zinc oxide, which is then leached at pH 2.0 to 4.0, in a process named Neutral Leaching. The pulp produced is thickened. The thickener underflow, also referred to as neutral underflow, containing zinc and indium ferrites, goes through a new mild leaching and is thickened again. The underflow of this mild leaching contains indium and feeds the fuming process (that is, the process to produce fumes of zinc oxide) to produce zinc oxide. The overflow of the mild leaching also contains indium in lower proportion and may or may not be part of the global process of indium recovery.

This invention is suited to both situations, where the fumes of zinc oxide and/or fumes of oxide and mild leaching overflow are processed and characterized for comprising the following steps:
a) Production of Indium Pre-concentrate;
b) Production of Indium Cement comprised, in turn, of at least a mild leaching and at least one strong leaching of the indium cement product obtained in the reducing leaching;
c) Production of Indium Solution;
d) Extraction of Indium by Organic Solvent;
e) Electrolysis of Indium;
f) Fusion, Purification, and Ingoting of the Metal;
g) electrolysis of indium to obtain a product with high purity, i.e. more than 99.995%.

The new technology is based on the simple and economic extraction of indium from metal traits contained in the zinc concentrates. When only zinc oxide is used, the process is more compact because the iron element was already extracted in the fuming step (or during the production process of zinc oxide fumes). When the complete process is used, with the contribution of the metal originated from the Mild Acid Leaching, there is one more step in the process to remove the iron, but larger amounts of indium are recovered in this process.

Enclosed you will find the following figures:

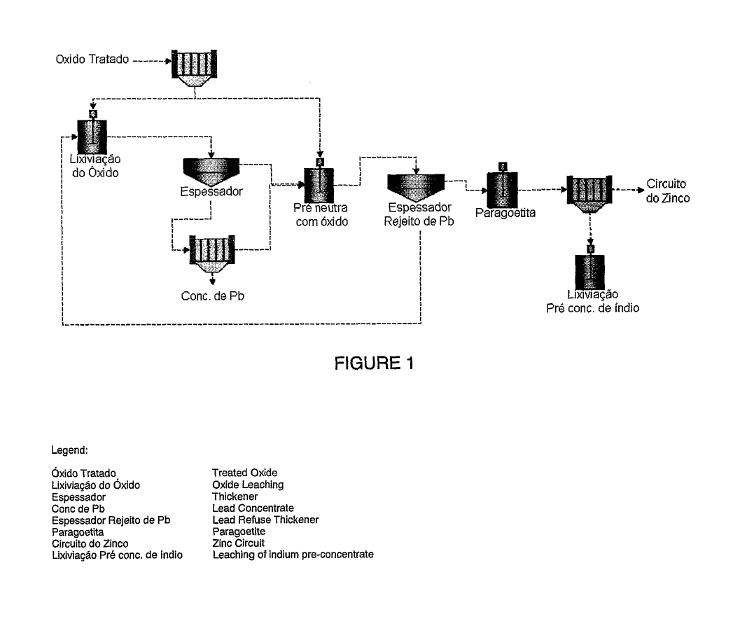

FIG. 1 shows a flow chart of leaching of Waelz oxide fumes;

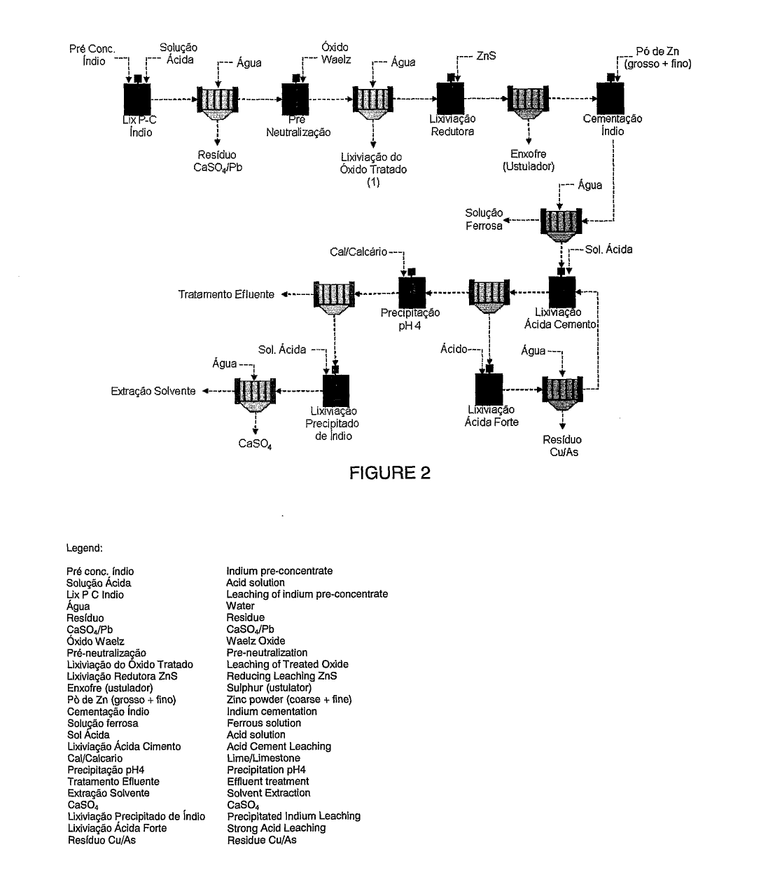

FIG. 2 shows an indium production flow chart;

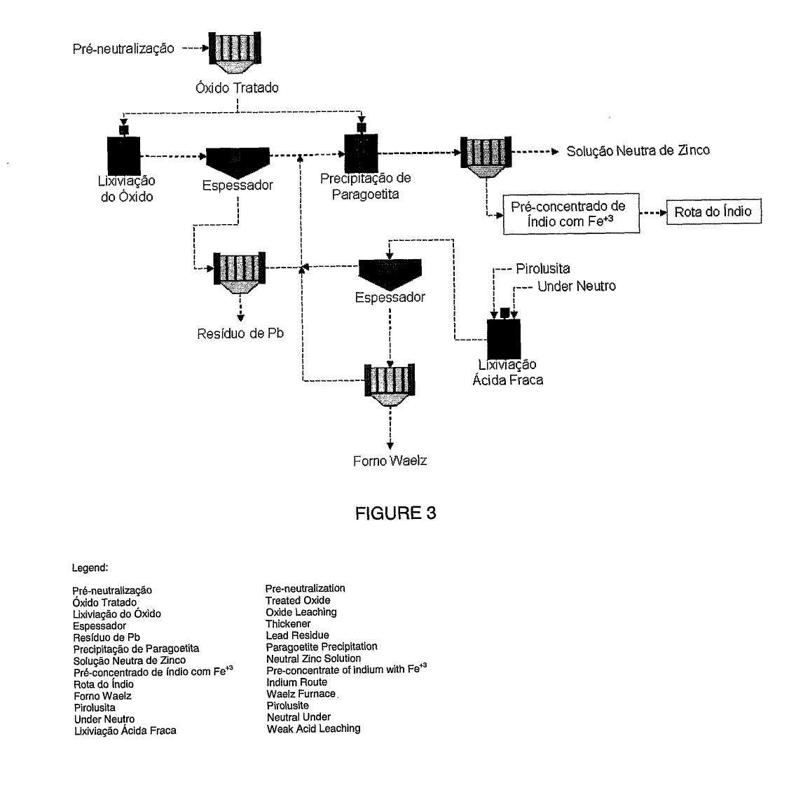

FIG. 3 describes an indium recovery flow chart with weak acid leaching of neutral underflow;

Attachment 1 presents the balance of masses of indium recovery;

Attachment 2 presents the results of the process without the inclusion of mild leaching overflow.

(a) Production of Pre-Concentrate:

The production step of indium pre-concentrate comprises three basic processes: Leaching of Waelz Zinc Oxide or fuming (or in the process of production of zinc oxide fumes); Pre-Neutralization of the pulp obtained and Precipitation of Indium jointly with paragoetite or an iron composite.

If the process includes the liquid part of Weak Acid Leaching of Neutral Underflow, the liquids are found in the Indium Precipitation stage with Paragoetite or iron composite, as illustrated in the flow chart of FIG. 3.

FIG. 1 illustrates the flow chart of the pre-concentrate production stage (a).

The Waelz zinc oxide is leached at temperatures ranging from 70 to 80° C. with a free acidity in the range of 50-70 g/L of sulphuric acid for 2 to 4 hours. The pulp produced is decanted or filtered. The indium is found in the liquid part, which then feeds the Pre-Neutralization stage. The pre-neutralization occurs at temperatures ranging from 60 to 80° C. for around 1 hour of residence time, and the final acidity must be in the range of 10 to 15 g/L of sulphuric acid. Then, the decantation or filtration process is carried out.

The acidity of 10 to 15 g/L is not sufficient to remove the indium. Therefore, the metal is also found in the liquid part that feeds the Precipitation stage of indium with paragoetite. This precipitation must occur at temperatures ranging from 70 to 80° C., using a pulp of lime, limestone, Waelz zinc oxide itself or another neutralizer, with a residence time of approximately 1 hour. The pulp is decanted or filtered. Then, the solid contains the indium, which we call the indium and iron pre-concentrate. The amount of indium in this pre-concentrate may reach approximately 0.2 to 0.5% depending on the initial amount of indium in the concentrate and the fuming efficiency. FIG. 1 contains the flow chart of the pre-concentrate production stage.

(b) Production of Indium Cement:

The production of indium cement begins with the leaching of the indium and iron pre-concentrate made through the acid solution with approximately 400 g/L of sulphuric acid at temperatures between 60 and 90° C. for approximately 3 hours. The flow chart in FIG. 2 shows the complete circuit of cement production. The final acidity must be controlled in the range of 50 g/L of sulphuric acid. The pulp is then filtered or thickened. The solid part of the thickening or filtering is a lead sulphide concentrate (with amounts beyond 50% of Pb). The filtered or liquid contains indium and iron that must proceed to the next pre-neutralization step.

The pre-neutralization occurs with an alkaline or basic reagent and lime, limestone or Waelz zinc oxide itself may be used. The operational conditions are temperatures between 60 to 70° C., retention time of approximately 1 hour, maintaining the final acidity in 15 to 20 g/L of sulphuric acid. Again, the pulp is decanted or filtered. The liquid part contains indium and ferric iron, which proceeds to the reducing leaching, the principle of which is the oxi-reduction of ferric iron to ferrous iron.

The reducing leaching occurs at temperatures from 90 to 95° C. for a retention time of 2 hours. The reducing agent is the concentrate of zinc and lead sulphides itself. At the end of the reaction, the free acidity must still be maintained between 10 and 15 g/L of sulphuric acid. The pulp is then decanted or filtered. The liquid part proceeds to the cementing stage of indium with scrap zinc and zinc powder. The operational conditions are temperature between 60 and 70° C., retention time of approximately two hours and final pH at 4.0 to 4.2. This indium precipitation agent may also be zinc oxide with pH between 4 and 4.2. The pulp is filtered and then washed with water. The liquid obtained is a solution obtained from zinc and ferrous iron, which must be forwarded to the zinc circuit for the appropriate precipitation of the iron. The solid part contains the indium cement, whose metal amount may reach up to 3%.

The indium cement is then subject to two or more leachings. One strong and one weak leaching in countercurrents. The weak leaching of cement occurs at temperatures of 90° C. for approximately 3 hours with an acid solution to obtain the final acidity of 10 to 20 g/L of sulphuric acid. The pulp obtained is then decanted or filtered. The solid part proceeds to the strong acid leaching. This stage occurs at temperatures of 90° C. for 4 hours, maintaining a final acidity of 100 g/L of sulphuric acid. The pulp is decanted or filtered. The solid part obtained is a copper concentrate. The liquid part, rich in sulphuric acid, is used to make the weak acid leaching (in countercurrent). The liquid part of the weak acid leaching, rich in indium, proceeds to the indium precipitation stage with lime, limestone, sodium or another neutralizing agent. The effect of the extraction through solvent is the concentration of indium. Hence, the indium precipitation stage with lime, limestone, soda or another neutralizing agent can be eliminated in some cases with the use of extraction through solvent for the solution diluted in an O/A relation above 3. In this case, the solution obtained will be ready to feed the extraction stage through organic solvent.

The precipitation of indium occurs with pH between 4 and 4.5 for approximately 2 hours, where the initial acidity of approximately 15 to 20 g/L is neutralized with the indicated agents. The pulp is then filtered. The filtered that is poor in zinc and other elements proceeds to a treatment of effluents. The solid part proceeds to the leaching of the indium concentrate. Here begins the production of the indium solution for extraction through organic solvent.

(c) Production of Indium Solution:

The production of the indium solution with final amounts between 1.5 to 5.0 g/L of the metal occurs during the leaching of the concentrate at temperatures from 60 to 80° C. and a retention time of approximately 2 hours. The pulp obtained is filtered and washed with water. The indium solution must contain at least 1.5 g/L of the metal. This is a good condition to feed the extraction unit by organic solvent.

d) Extraction of Indium by Organic Solvent:

The extraction of the indium contained in the liquor is carried out in FRP cells (fiber-reinforced plastic, a composite material made of a polymer matrix reinforced with fibers), which have pump mixers (stirrers with simultaneous pumping), where the indium present in the aqueous phase is transferred to the organic phase.

The process uses an organic phase containing mono-, di-, or tri-alkylphosphoric acid in organic solvent, for instance, a solution containing 25% DEPA-hexyl phosphoric acid-in kerosene to promote the selective extraction of the indium in the O/A outflow relation=1/7.5 (O/A organic phase relation to aqueous phase). The organic phase charged with indium feeds the stripping or re-extraction stage, which is also performed in 3 or more cells, preferably identical in the O/A outflow relation=3/1.

The stripping or re-extraction agent is preferably the hydrochloric acid, such as, for instance, in a 6M HCL solution that enables the production of indium chloride solution.

The stripping agent is a 6M HCL solution that enables the production of indium chloride solution with the following approximate composition, as indicated in Table 1 below:

TABLE 1

| In (g/l) | Cu (mg/l) | Pb (mg/l) | Fe (mg/l) | Zn (mg/l) |
|---|---|---|---|---|
| 80-100 | 35 | 60 | 6-8 | 10-15 |

Later, the solution can be subject to the purification process with the addition of H2S, if necessary.

The purified solution has the following approximate composition, as indicated in Table 2 below:

TABLE 2

| In (g/l) | Cu (mg/l) | Pb (mg/l) | Fe (mg/l) | Zn (mg/l) |
|---|---|---|---|---|
| 80-100 | 0.01 | 0.01 | 1.5 | 1-5 |

(e) Indium Cementation:

The technology adopted to obtain indium is the cementation process for 24 hours or until it reaches 0.02 g/L of In, using aluminum plates, according to the reaction below:

In+3+Al→Al+3+In

(f) Fusion, Purification, and Ingoting of the Metal;

The cements produced are washed with water and pressed (2 kg) to form brickets with diameter and thickness of 5 cm. The fusion of the bricket is carried out in a furnace at 260° C., with sodium hydroxide as the scorifying agent.

The indium is refined in another furnace with the addition of ammonia chloride with strong stirring. This refining can also be made in the same fusion furnace and the addition of ammonia chloride is option for the purification of the metal.

The slag formed is removed with a skimmer and the metal is manually poured into ingots of 100 OZ (approximately 3.1 kg), packed into wood boxes with 10 ingots.

The product presents a minimum of 99.99% of indium, with the maximum impurity of 100 ppm. A product with at least 97% of purity can also be obtained if the impurity amounts of the solution and purification of the metal are kept in higher levels. In this case, the electrolytic purification can guarantee a much higher purity, beyond 99.995%.

The indium ingot of 99.9910% has the following approximate impurity composition, as shown in Table 3 below:

TABLE 3
Approximate impurity composition of Indium Ingot 99.99%

| Ag (ppm) | Cu (ppm) | Pb (ppm) | Fe (ppm) | Zn (ppm) |
|---|---|---|---|---|
| 1 | 15 | 30 | 1 | 40 |

(g) Production of Electrolytic Indium of Minimum Purity of 99.995%:

The production of electrolytic indium of minimum purity of 99.995% of indium is carried out through the sub-processes below:
(g-1) Production of the Indium Anode
(g-2) Active Electrolysis
(g-3) Fusion of the Anodes and Purification
(g-4) Ingoting of the fused indium
   (g-1) Production of the Indium Anode:

The indium ingot with purity above 97% is melted with soda (NaOH) or another flux at 260° C. to form an impure indium anode.

(g-2) Active Electrolysis:

The electrolysis of indium consists of one electrolytic cell with an indium anode of purity equal or above 97% and a titanium cathode. The electrolysis operation conditions are: electric current density of 0.02 to 0.03 A/m2; indium chloride solution with at least 100 g/L of the amount of the dissolved metal; gelatin in approximate concentration of 0.1 g/L. The surface of the fused anodes must not include oxides, i.e. polished and glossy. The high purity indium is then deposited on the titanium cathode, and the deposit is removed at determined intervals (24, 32, or 48 hours).

The indium cathode obtained must be washed with acid water, then with water, and then dried at approximately 50 to 60° C.

(g-3) Fusion of the Anodes and Purification:

The fusion of the indium cathode occurs at 260° C. with soda or another flux, and ammonia chloride may be used as purifier, if necessary.

(g-4) Ingoting of the Fused Indium:

The fused indium is poured into ingot molds to produce ingots of 1 to 3 kg. The maximum impurity composition in the indium ingot 99.995% will be in ppm: Cd max 2; copper max 10; tin max 2; iron max 5; nickel max 5; minor silver 0.1; lead max 10; thallium max 2, bismuth max 2, and zinc max 5, so that the sum of such impurities is below 50 ppm.

The following are examples intended to better illustrate the invention. However, they do not limit the invention.

### EXAMPLE 1

### Indium Process Including Contribution of Mild Leaching of Neutral Underflow—Flow Chart FIG. 3 And Results Attachment 1:

Amount of indium in the Waelz zinc oxide: 0.0510
Amount of indium in the liquid part of the mild leaching of neutral underflow: 15 mg/L
Indium solution produced—amount of indium 1.85 g/L
Solution after extraction with solvent—amount of indium 93 g/L
Metal produced—indium 99.992%
Total recovery—77%

### EXAMPLE 2

### Indium Recovery Process Without the Inclusion of Contribution of Mild Leaching Overflow of Neutral Underflow

Amount of indium in the Waelz zinc oxide: 0.03800
Amount of indium in the liquid part of the mild leaching of neutral underflow: not considered.
Indium solution produced—amount of indium 1.85 g/L
Solution after extraction with solvent—amount of indium 97 g/L
Metal produced—indium 99.993%
Total recovery—78%

### EXAMPLE 3

Extraction of indium by organic solvent:
The extraction of the indium contained in the liquor was performed in FRP cells provided with Pump Mixers, where the indium present in the aqueous phase was transferred to the organic phase.

The process makes use of an organic phase containing 25% DEPA (hexyl phosphoric acid) in kerosene for the selective extraction of indium in the O/A outflow relation=1/7.5. The organic phase charged with indium fed the stripping or re-extraction phase, which was also performed in 4 identical cells in the O/A relation=3/1.

The stripping or re-extraction agent used was a 6M HCL solution that enabled the production of an indium chloride solution with the following approximate composition, as indicated in Table 4 below:

TABLE 4

| In (g/l) | Cu (mg/l) | Pb (mg/l) | Fe (mg/l) | Zn (mg/l) |
|---|---|---|---|---|
| 80-100 | 35 | 60 | 6-8 | 10-15 |

The purified solution presented the following approximate composition, as indicated in Table 5 below:

TABLE 5
Approximate composition of the purified solution

| In (g/l) | Cu (mg/l) | Pb (mg/l) | Fe (mg/l) | Zn (mg/l) |
|---|---|---|---|---|
| 80-100 | 0.01 | 0.01 | 1.5 | 1-5 |

ATTACHMENT 1

| | | | | | Weak | | | | | | | |
|---|---|---|---|---|---|---|---|---|---|---|---|---|
| | | | | | Acid | | | | | | | |
| | | | | | Leach- | Precipitation of | | Leaching of Indium Pre- | | | | |
| | | | | | ing | Indium with | | concentrate | | | | |
| | Acid leaching | | Pre-neutralization I | | Weak | Paragoetite | | Indium | Leaching | | | |
| | Waelz | Lead | Waelz | Lead | LA | Waelz | | pre- | of indium | Refuse of | Pre-neutralization II | |
| | Oxide | Concentrate | oxide | Refuse | Solution | oxide | PH 7.0 | conc. | pre-conc. | pre-conc. | Ustulated | |
| Mass | 7333 | 602 | 3062 | 33 | ** | 1865 | 4910 | 5257 | | 2380 | 670 | 427 |
| Kg/hour | | | | | | | | | | | | |
| H₂O % | 38.5 | 0 | 38.5 | | *** | 38.5 | 60 | 52.84 | | 51.6 | 0 | 45 |
| Kg/hour | 4510 | 602 | 1883.1 | 33 | *** | 1147.0 | 1964 | 2479 | | 1151.92 | 670 | 234.85 |
| (Bs) | | | | | | | | | | | | |
| Flow | | | | | 36 | | 4214 | | 13.3 | | 13.3 | |
| (m³/hour) | | | | | | | | | | | | |
| Indium % | 0.051 | 0.015 | 0.051 | 0.0288 | | 0.051 | | 0.181 | | 0.0171 | | 0.042 |
| Indium g/l | | | | | 0.018 | | | | 0.322 | | 0.235 | |
| Indium | 2.3000 | 0.0903 | 0.9604 | 0.0095 | 0.6480 | 0.5850 | | 4.4874 | 4.2826 | 0.1970 | 3.126 | 0.0986 |
| (kg) | | | | | | | | | | | | |
| Total | | | | | | 4.4933 | | | | | | |
| Indium | | | | | | | | | | | | |
| (kg) | | | | | | | | | | | | |
| Yield % | | 97.99 | | | | | | | | 95.62 | | |

| | Reducing Leaching | | | | Leaching of Indium | | Strong Acid | | | Leaching of Indium | |
|---|---|---|---|---|---|---|---|---|---|---|---|
| | | Refuses of | Indium Cementation | | Cement | | Leaching | Neutralization pH 4.0 | | concentrate | |
| | Reducing | ZnS | Indium | Ferrous | Cu/As | Indium | Cu/As | Secondary | Indium | Indium | CaSO₄ |
| | Leaching | Reducer | Cement | Solution | Residue | Solution | Refuse | solution | concent. | solution | Refuse |
| Mass Kg/hour | 793 | 1281 | 540 | | | | | | 747 | | 784 |
| H₂O % | 9 | 25 | 45.2 | | | | | | 46 | | 47.83 |
| kg/hour (Bs) | 721.63 | 960.8 | 295.9 | | 82.1 | | 42 | | 403.38 | | 409.0 |
| Flow (m³/hour) | 13.9 | | | 14.37 | | 4.48 | | 5.32 | | 2.22 | |
| Indium % | | 0.0351 | 1.51 | | 0.425 | | 0.3378 | | 1.02 | | 0.121 |
| Indium g/l | 0.322 | | | 0.0052 | | 0.92 | | 0.0053 | | 1.85 | |
| Indium (kg) | 4.4758 | 0.3372 | 4.468 | 0.0747 | 0.349 | 4.122 | 0.1419 | 0.02820 | 4.11 | 4.107 | 0.495 |
| Yield % | | | | 91.94 | | | 88.79 | | | | 77.14 |

ATTACHMENT 2
Simulation of the Industrial Flow - Mass balance and flow/hour in October 2006

| | | | | | | | | | Indium | |
|---|---|---|---|---|---|---|---|---|---|---|
| | | Mass | | Mass | Liquid | | | Indium | Total | |
| | | Kg (Bu) | H₂O % | Kg (Bs) | (m³) | Indium % | Indium g/l | (kg) | (kg) | Yield % |
| Acid Leaching | Waelz Oxide | 7589 | 36% | 4857.0 | | 0.04 | | 1.9428 | 1.9428 | |
| | Lead Concentrate | 1038 | 0% | 1038.4 | | 0.0062 | | 0.0644 | | 96.69 |
| Pre-Neutralization I | Waelz Oxide | 2731 | 36% | 1747.8 | | 0.04 | | 0.6991 | 2.6419 | |
| | Solution | | | | 44.1 | | 0.06 | 2.6478 | | |
| | Lead Refuse | 95.02 | 0% | 95.0 | | 0.0123 | | 0.0117 | | |
| Precipitation of Indium as | Waelz Oxide | 892 | 36.00% | 570.9 | | 0.04 | | 0.2284 | 2.8703 | |
| [with] Paragoetite | PH 7.0 | 843.3 | 0% | 843.3 | 5.19 | | | | | |
| | ZnSO₄ solution | | | | 45.0 | | 0.0024 | 0.108 | | |
| | Indium Pre-concentrate | 2434.9 | 52.04% | 1167.8 | | 0.23 | | 2.6859 | | 93.58 |
| Leaching of Indium Pre- | Solution | | | | 8.31 | | 0.329 | 2.7329 | | |
| concentrate | Refuse of pre-concent. | 860.6 | 0% | 860.6 | | 0.0073 | | 0.0628 | | 91.40 |
| Pre-neutralization II + | Waelz Oxide | 254 | 36% | 162.6 | | 0.04 | | 0.065 | 2.9353 | |
| Reducing LX | ZnS concentrate | 605.7 | 9% | 551.2 | | 0.015 | | 0.0827 | | |
| | Solution | | | | 8.57 | | 0.328 | 2.519 | | |
| | Pb/ZnS Refuse | 874.9 | 27.40% | 635.1 | | 0.0121 | | 0.0769 | | 85.82 |
| Indium Cementation | Zinc scrap | 108 | 0 | 25.0 | | | | | | |
| | Zinc powder | 78 | 0 | 16.0 | | | | | | |
| | Indium cement | 377.1 | 30% | 264.0 | | 0.97 | | | 2.5603 | 87.23 |
| | Ferrous solution | | | | 8.709 | | 0.016 | 0.1393 | | |
| Leaching of Indium | Indium solution | | | | 3.03 | | 0.713 | 2.159 | | |
| Cement | Cement residue | 58.8 | 0% | 58.8 | | 0.494 | | 0.291 | | 83.00 |
| | Acid Pulp | | | | 1.73 | | 0.16 | 0.277 | | |
| | Cu/As Refuse | 20.3 | 0% | 20.3 | | 0.091 | | 0.019 | | |
| Neutralization pH 4.0 | Lime | 99.5 | 0% | 99.5 | | | | | | |
| | Solution | | | | 4.24 | | 0.005 | 0.02120 | | |
| | Indium concentrate | 549 | 56% | 241.8 | | 0.85 | | 2.0550 | | 79.443 |
| Leaching of indium | Indium solution | | | | 1.12 | | 1.74 | 1.957 | 1.957295 | |
| concentrate | CaSO₄ refuse | 454 | 56% | 199.9 | | 0.05 | | 0.0999 | | 76.11 |

1. PROCESS FOR PRODUCING PURE METALLIC INDIUM FROM ZINC OXIDE AND/OR SOLUTION CONTAINING THE METAL, comprising:
a) Production of indium pre-concentrate;
b) production of indium cement: comprised, in turn, of at least a mild leaching and at least one strong leaching of the indium cement product obtained in the reducing leaching;
c) Production of indium solution;
d) Extraction of indium by organic solvent;
e) Electrolysis of indium;
f) Fusion, purification, and ingoting of the metal;
g) Electrolysis of indium to obtain a product with high purity, above 99.995%.

2. PROCESS FOR PRODUCING PURE METALLIC INDIUM FROM ZINC OXIDE AND/OR SOLUTION CONTAINING THE METAL, according to claim 1, further comprising use of sulphured concentrates of zinc and lead as sources of metal.

3. PROCESS FOR PRODUCING PURE METALLIC INDIUM FROM ZINC OXIDE AND/OR SOLUTION CONTAINING THE METAL, according to claim 1, wherein the solution or zinc oxide contains or does not contain iron.

4. PROCESS FOR PRODUCING PURE METALLIC INDIUM FROM ZINC OXIDE AND/OR SOLUTION CONTAINING THE METAL, according to claim 3, wherein in the case in which it contains iron, it can be previously extracted in the stage of production of zinc oxide fumes.

5. PROCESS FOR PRODUCING PURE METALLIC INDIUM FROM ZINC OXIDE AND/OR SOLUTION CONTAINING THE METAL, according to claim 1, wherein the stage (a) can be comprised of acid leaching of zinc oxide, pre-neutralization of the pulp obtained, and precipitation of the indium.

6. PROCESS FOR PRODUCING PURE METALLIC INDIUM FROM ZINC OXIDE AND/OR SOLUTION CONTAINING THE METAL, according to claim 5, wherein the liquid part containing indium and obtained through leaching passes to the pre-neutralization stage.

7. PROCESS FOR PRODUCING PURE METALLIC INDIUM FROM ZINC OXIDE AND/OR SOLUTION CONTAINING THE METAL, according to claim 5, wherein the pre-neutralization occurs at temperature and acidity conditions that are milder than those of leaching.

8. PROCESS FOR PRODUCING PURE METALLIC INDIUM FROM ZINC OXIDE AND/OR SOLUTION CONTAINING THE METAL, according to claim 5, wherein the feeding of the leaching stage of the indium pre- concentrate leaching may be carried out using the solid or liquid part obtained after filtration or decantation of the pre-neutralized oxide.

9. PROCESS FOR PRODUCING PURE METALLIC INDIUM FROM ZINC OXIDE AND/OR SOLUTION CONTAINING THE METAL, according to claim 1, wherein in stage (a) the precipitation of iron may occur jointly with paragoetite or a composite with iron.

10. PROCESS FOR PRODUCING PURE METALLIC INDIUM FROM ZINC OXIDE AND/OR SOLUTION CONTAINING THE METAL, according to claim 1, wherein the stage (b) comprises leaching of the indium pre-concentrate, pre-neutralization, reducing leaching, and cementation of indium.

11. PROCESS FOR PRODUCING PURE METALLIC INDIUM FROM ZINC OXIDE AND/OR SOLUTION CONTAINING THE METAL, according to claim 10, wherein the thickening and filtration of the product of leaching of the pre-concentrate produces a solid part, comprised of lead sulphate, and that the filtered or the liquid part proceed to the pre-neutralization stage.

12. PROCESS FOR PRODUCING PURE METALLIC INDIUM FROM ZINC OXIDE AND/OR SOLUTION CONTAINING THE METAL, according to claim 10, wherein the pre-neutralization occurs in the presence of alkalinizing or basic agent, with the product being decanted or filtered, and the liquid part forwarded to the reducing leaching stage.

13. PROCESS FOR PRODUCING PURE METALLIC INDIUM FROM ZINC OXIDE AND/OR SOLUTION CONTAINING THE METAL, according to claim 10, wherein a reduction of ferric iron to ferrous iron occurs in the reducing leaching stage.

14. PROCESS FOR PRODUCING PURE METALLIC INDIUM FROM ZINC OXIDE AND/OR SOLUTION CONTAINING THE METAL, according to claim 10, wherein the reducing agent can be the concentrated of sulphides of zinc and lead.

15. PROCESS FOR PRODUCING PURE METALLIC INDIUM FROM ZINC OXIDE AND/OR SOLUTION CONTAINING THE METAL, according to claim 10, wherein the pulp or product of reducing leaching is decanted or filtered, with the liquid part containing zinc and ferrous iron forwarded to the zinc circuit, and the solid part containing indium cement proceeds to the indium cementation stage.

16. PROCESS FOR PRODUCING PURE METALLIC INDIUM FROM ZINC OXIDE AND/OR SOLUTION CONTAINING THE METAL, according to claim 15, wherein the indium cement is subject to two or more leachings, with at least one mild and one strong leaching in countercurrent.

17. PROCESS FOR PRODUCING PURE METALLIC INDIUM FROM ZINC OXIDE AND/OR SOLUTION CONTAINING THE METAL, according to claim 16, wherein the underflow obtained through strong leaching can be recycled to the liquid part of the mild leaching stage.

18. PROCESS FOR PRODUCING PURE METALLIC INDIUM FROM ZINC OXIDE AND/OR SOLUTION CONTAINING THE METAL, according to claim 15, wherein the liquid part of the weak leaching containing indium proceeds to the indium precipitation stage with neutralizing agent.

19. PROCESS FOR PRODUCING PURE METALLIC INDIUM FROM ZINC OXIDE AND/OR SOLUTION CONTAINING THE METAL, according to claim 18, wherein the solid product obtained by filtration or decantation of the leaching of the indium concentrate proceeds to the production stage of the indium solution.

20. PROCESS FOR PRODUCING PURE METALLIC INDIUM FROM ZINC OXIDE AND/OR SOLUTION CONTAINING THE METAL, according to claim 1, wherein the stage (c) is comprised of the production of indium solution through the leaching of the concentrate obtained in the previous stage, forwarded at the end to the filtration and washing with water.

21. PROCESS FOR PRODUCING PURE METALLIC INDIUM FROM ZINC OXIDE AND/OR SOLUTION CONTAINING THE METAL, according to claim 1, wherein the solution obtained in stage (c) proceeds to stage (d) which is extraction of the indium by an organic solvent.

22. PROCESS FOR PRODUCING PURE METALLIC INDIUM FROM ZINC OXIDE AND/OR SOLUTION CONTAINING THE METAL, according to claim 21, comprising the use of mono-, di-, or tri-alkylphosphoric acid as the organic phase in organic solvent.

23. PROCESS FOR PRODUCING PURE METALLIC INDIUM FROM ZINC OXIDE AND/OR SOLUTION CONTAINING THE METAL, according to claim 21, wherein the extraction agent is hydrochloric acid.

24. PROCESS FOR PRODUCING PURE METALLIC INDIUM FROM ZINC OXIDE AND/OR SOLUTION CONTAINING THE METAL, according to claim 1, wherein the metallic indium can be obtained by electrolysis (stage e) with the use of aluminum plates.

25. PROCESS FOR PRODUCING PURE METALLIC INDIUM FROM ZINC OXIDE AND/OR SOLUTION CONTAINING THE METAL, according to claim 1, wherein in the formation of the bricket (stage (f)), caustic soda can be used as scorifying agent, and ammonia chloride can be used in the refining of indium.

26. PROCESS FOR PRODUCING PURE METALLIC INDIUM FROM ZINC OXIDE AND/OR SOLUTION CONTAINING THE METAL, according to claim 1, wherein any of the sub-processes indicated below can occur in stage (g) or in the production of high purity electrolytic indium:
(g-1) Production of the Indium Anode; or,
(g-2) Active Electrolysis; or,
(g-3) Fusion of the anodes and purification; or,
(g-4) Ingoting of the fused indium.

27. PURE METALLIC INDIUM obtained according to claim 1, wherein it can be in the shape of brickets with diameter, thickness of approximately 5 cm and purity more than 99.995%.
